(19) United States
(12) Patent Application Publication
(10) Pub. No.: US 2026/0323687 A1
(43) Pub. Date: Oct. 15, 2026

(54) SEMI-STATIC AND DYNAMIC CHANNEL ACCESS FOR SIDELINK COMMUNICATIONS OVER UNLICENSED BANDS

(71) Applicant: Parsa Wireless Communications LLC, Stamford, CT (US)

(72) Inventor: Alireza Babaei, Fairfax, VA (US)

(73) Assignee: Parsa Wireless Communications LLC, Stamford, CT (US)

(21) Appl. No.: 18/999,984

(22) PCT Filed: Jun. 21, 2023
(86) PCT No.: PCT/US2023/025812

§ 371 Date: Dec. 23, 2024

Related U.S. Application Data
(60) Provisional application No. 63/354,711, filed on Jun. 23, 2022.

(51) Int. Cl. H04W 74/0808; H04W 24/10; H04W 92/18

(52) U.S. Cl. CPC H04W 74/0808; H04W 24/10; H04W 92/18

(57) ABSTRACT

A method of sidelink communications in unlicensed bands includes receiving, by a first user equipment (UE) from a base station, one or more messages comprising channel access configuration parameters used in sidelink communications via radio resources of an unlicensed band; performing a channel access process based on the channel access configuration parameters; and transmitting, by the first UE to a second UE, sidelink data or control information based on the channel access process indicating that sidelink communications are allowed to be performed.

### CROSS-REFERENCE TO RELATED APPLICATIONS

This application claims priority under 35 USC § 119(e) from U.S. Provisional Patent Application No. 63/354,711, filed on Jun. 23, 2022 (“the provisional application”); the content of the provisional patent application is incorporated herein by reference.

### BACKGROUND OF THE INVENTION

The present invention is directed to 5G, which is the 5^{th} generation mobile network. It is a new global wireless standard after 1G, 2G, 3G, and 4G networks. 5G enables networks designed to connect machines, objects and devices.

The invention is more specifically directed to systems and/or methods for enhancing existing sidelink processes when a user equipment (UE) is configured to perform sidelink data and/or control transmission via unlicensed resources.

In an embodiment, the invention provides a method of sidelink communications in unlicensed bands includes receiving, by a first user equipment (UE) from a base station, one or more messages comprising channel access configuration parameters used in sidelink communications via radio resources of an unlicensed band; performing a channel access process based on the channel access configuration parameters; and transmitting, by the first UE to a second UE, sidelink data or control information based on the channel access process indicating that sidelink communications are allowed to be performed. The channel access process may be used by the first user equipment (UE) to determine whether unlicensed radio resources are available for sidelink communications. The channel access process may be a semi-static channel access process. The semi-static channel access process may be based on a fixed frame period (FFP). Instances in which the channel access is performed may be based on the fixed frame period (FFP). The channel access process may be a dynamic channel access process.

The channel access process may be for first radio resources that are approximately 20 MHz in a frequency domain. A subset of resource blocks of an unlicensed band used for Uu interface communications and a second subset of resource blocks of the unlicensed band used for sidelink communications may be disjoint subsets. A first subset of time periods that are used for Uu interface communications and a second subset of time periods that are used for sidelink communications may be disjoint subsets. The method also can include receiving first configuration parameters indicating per resource block set (RBS) configuration or per carrier configuration of a type of the channel access process. The first configuration parameters can indicate which resource block sets (RBSs) or which carriers can use semi-static channel access process and which RBSs or which carriers can use a dynamic channel access process.

The first configuration parameters may further indicate a per resource block set (RBS) or a per carrier fixed frame period for a semi-static channel access process. The first configuration parameters may further indicate a per resource block set (RBS) or a per carrier sub-carrier spacing (SCS). The first configuration parameters may be user equipment (UE)-specific parameters. The first configuration parameters may be common among a plurality of user equipments (UEs). The first configuration parameters may indicate that both a semi-static channel access process and a dynamic channel access process are configured for a resource block set (RBS) or a carrier. The first configuration parameters may indicate one or more first conditions that define the channel access process as a semi-static channel access process and second conditions that define the channel access process as a dynamic channel access process for the resource block set (RBS) or the carrier.

The inventive method also can include determining, based on the one or more conditions, whether the channel access process for the resource block set (RBS) or the carrier is a semi-static channel access process or a dynamic channel access process. The inventive method also can include transmitting, by the first user equipment (UE) to the base station, channel congestion and measurement reports based on triggers related to listen-before-talk (LBT) failures. The method can include receiving one or more configuration parameters indicating the triggers or used for determining whether the triggers are satisfied. The method can include receiving updated channel access configuration parameters in response to transmitting the channel congestion and measurement reports. The method can include receiving information related to presence of nearby radio access technologies (RATs). The method can include receiving updated channel access configuration parameters in response to transmitting the information.

The channel access configuration parameters may indicate use of a semi-static channel access process or a dynamic channel access process based on a location or a geographical zone associated with the first user equipment (UE). The method can include receiving configuration parameters indicating rules for selecting resource block sets (RBSs) and carriers for sidelink communications in unlicensed bands. The rules may be user equipment (UE)-specific rules. The rules may be common rules that are applicable to a plurality of user equipments (UEs). The method can include transmitting a request for sidelink communications of a first type, wherein receiving the channel access configuration parameters is based on the first type. Receiving the channel access configuration parameters may be based on a broadcast message. The broadcast message may be a system information block (SIB) message. The system information block (SIB) message may be a SIB1 message.

### BRIEF DESCRIPTION OF THE DRAWINGS

FIG. 1 shows an example of a system of mobile communications according to some aspects of some of various exemplary embodiments of the present disclosure.

FIG. 2A and FIG. 2B show examples of radio protocol stacks for user plane and control plane, respectively, according to some aspects of some of various exemplary embodiments of the present disclosure.

FIG. 3A, FIG. 3B and FIG. 3C show example mappings between logical channels and transport channels in downlink, uplink and sidelink, respectively, according to some aspects of some of various exemplary embodiments of the present disclosure.

FIG. 4A, FIG. 4B and FIG. 4C show example mappings between transport channels and physical channels in downlink, uplink and sidelink, respectively, according to some aspects of some of various exemplary embodiments of the present disclosure.

FIG. 5A, FIG. 5B, FIG. 5C and FIG. 5D show examples of radio protocol stacks for NR sidelink communication according to some aspects of some of various exemplary embodiments of the present disclosure.

FIG. 6 shows example physical signals in downlink, uplink and sidelink according to some aspects of some of various exemplary embodiments of the present disclosure.

FIG. 7 shows examples of Radio Resource Control (RRC) states and transitioning between different RRC states according to some aspects of some of various exemplary embodiments of the present disclosure.

FIG. 8 shows example frame structure and physical resources according to some aspects of some of various exemplary embodiments of the present disclosure.

FIG. 9 shows example component carrier configurations in different carrier aggregation scenarios according to some aspects of some of various exemplary embodiments of the present disclosure.

FIG. 10 shows example bandwidth part configuration and switching according to some aspects of some of various exemplary embodiments of the present disclosure.

FIG. 11 shows example four-step contention-based and contention-free random access processes according to some aspects of some of various exemplary embodiments of the present disclosure.

FIG. 12 shows example two-step contention-based and contention-free random access processes according to some aspects of some of various exemplary embodiments of the present disclosure.

FIG. 13 shows example time and frequency structure of Synchronization Signal and Physical Broadcast Channel (PBCH) Block (SSB) according to some aspects of some of various exemplary embodiments of the present disclosure.

FIG. 14 shows example SSB burst transmissions according to some aspects of some of various exemplary embodiments of the present disclosure.

FIG. 15 shows example components of a user equipment and a base station for transmission and/or reception according to some aspects of some of various exemplary embodiments of the present disclosure.

FIG. 16 shows examples of per RBS SCS and FFP configuration with and without time exclusion according to some aspects of some of various exemplary embodiments of the present disclosure.

FIG. 17 shows examples of SL-U configuration and congestion report signaling according to some aspects of some of various exemplary embodiments of the present disclosure.

FIG. 18 shows an example process according to some aspects of some of various exemplary embodiments of the present disclosure.

### DETAILED DESCRIPTION

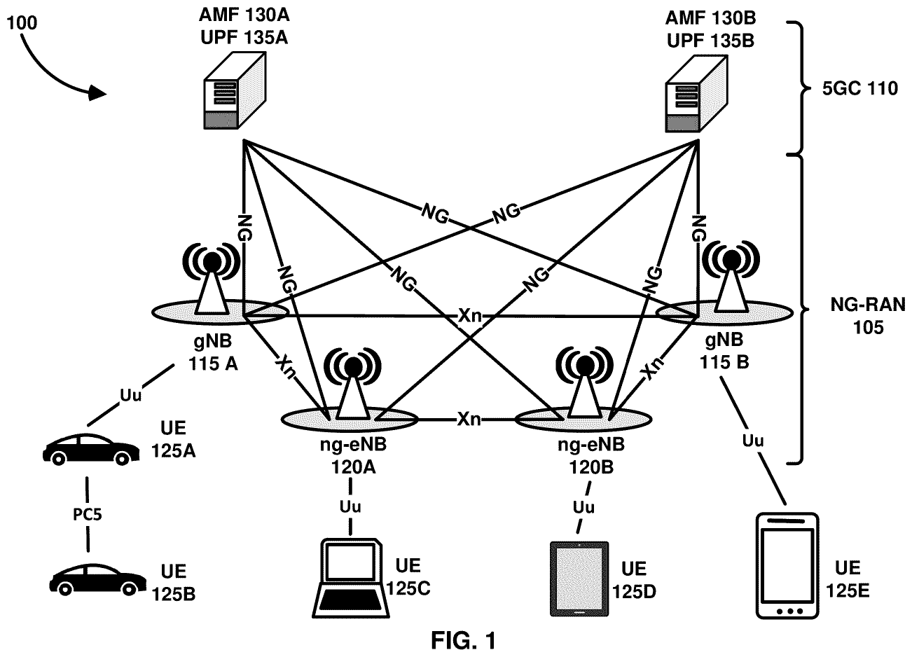

FIG. 1 shows an example of a system of mobile communications 100 according to some aspects of some of various exemplary embodiments of the present disclosure. The system of mobile communication 100 may be operated by a wireless communications system operator such as a Mobile Network Operator (MNO), a private network operator, a Multiple System Operator (MSO), an Internet of Things (IOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support applications with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5GC) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5GC 110) may be referred to as Non-access Stratum (NAS).

The UEs 125 may include wireless transmission and reception means for communications with one or more nodes in the RAN, one or more relay nodes, or one or more other UEs, etc. Examples of UEs include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for UEs such as a Mobile Station (MS), terminal equipment, terminal node, client device, mobile device, etc.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that uses the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and GPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multi-homed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may be a link-layer identity that identifies a device or a group of devices that are recipients of sidelink communication frames. The Destination Layer-2 ID may be a link-layer identity that identifies a device that originates sidelink communication frames. In some examples, the Source Layer-2 ID and the Destination Layer-2 ID may be assigned by a management function in the Core Network. The Source Layer-2 ID may identify the sender of the data in NR sidelink communication. The Source Layer-2 ID may be 24 bits long and may be split in the MAC layer into two bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering packets at the MAC layer of the receiver. The Destination Layer-2 ID may identify the target of the data in NR sidelink communication. For NR sidelink communication, the Destination Layer-2 ID may be 24 bits long and may be split in the MAC layer into two bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

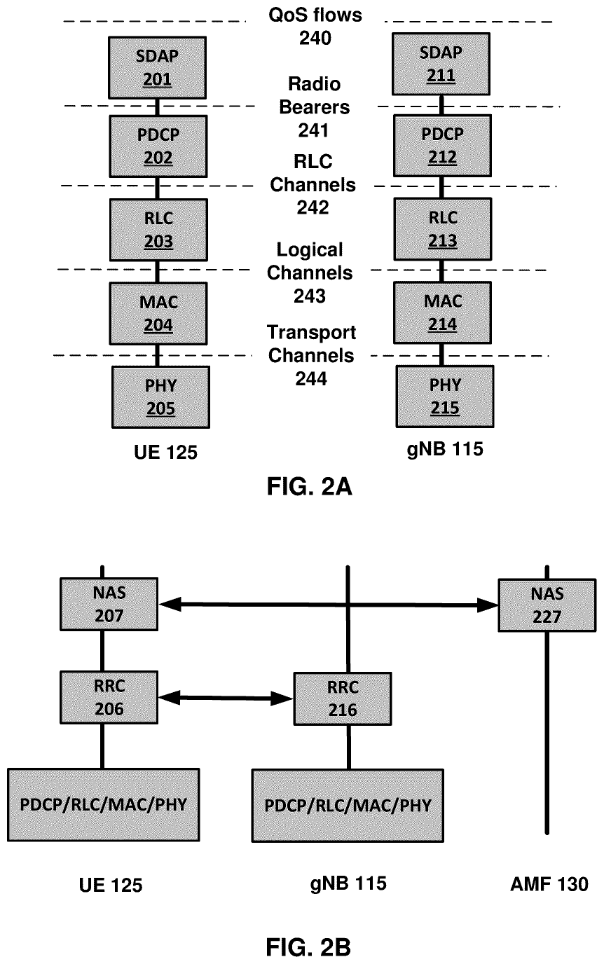

FIG. 2A and FIG. 2B show examples of radio protocol stacks for user plane and control plane, respectively, according to some aspects of some of various exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

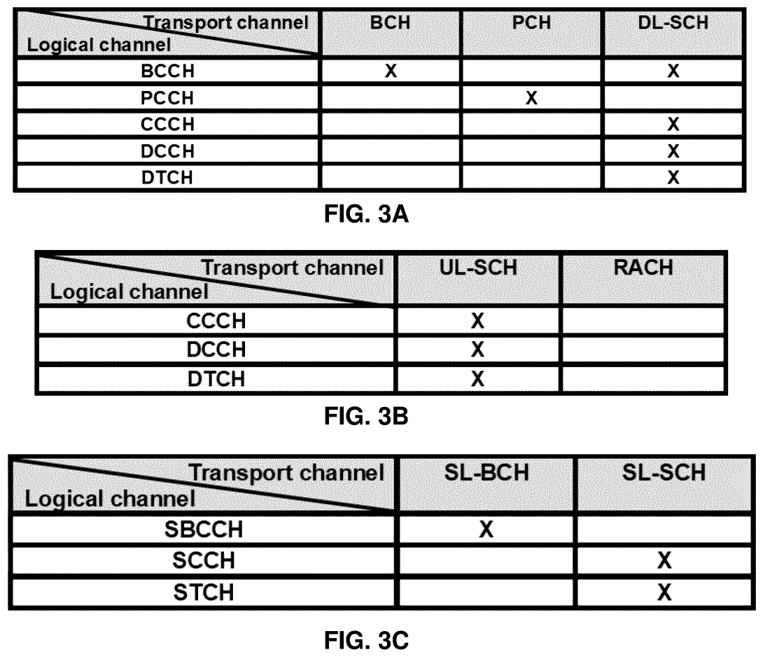

FIG. 3A, FIG. 3B and FIG. 3C show example mappings between logical channels and transport channels in downlink, uplink and sidelink, respectively, according to some aspects of some of various exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is channel for transmitting control information between UEs and networks. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UE power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

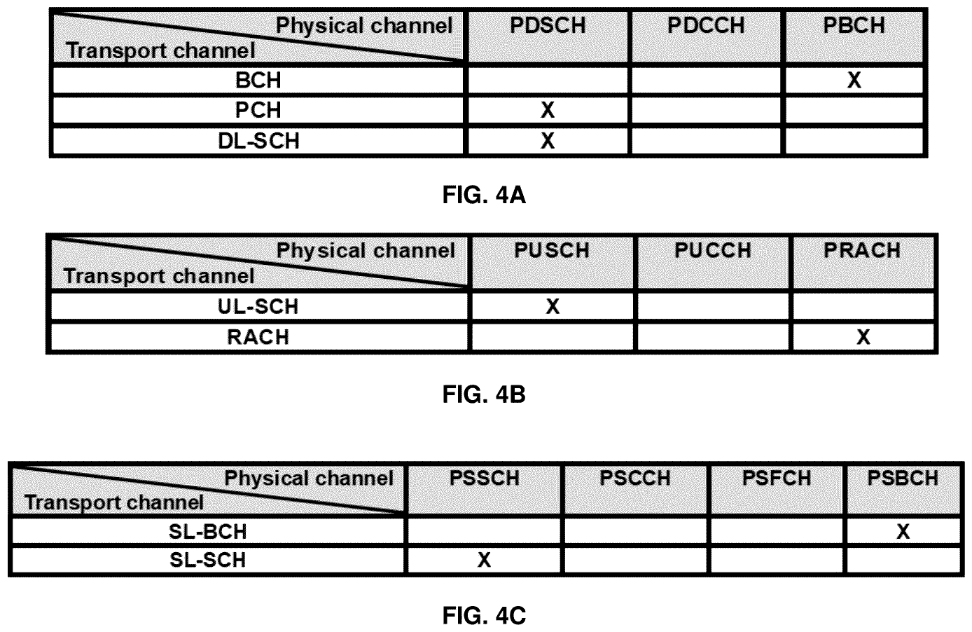

FIG. 4A, FIG. 4B and FIG. 4C show example mappings between transport channels and physical channels in downlink, uplink and sidelink, respectively, according to some aspects of some of various exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may mapped to the PSCCH.

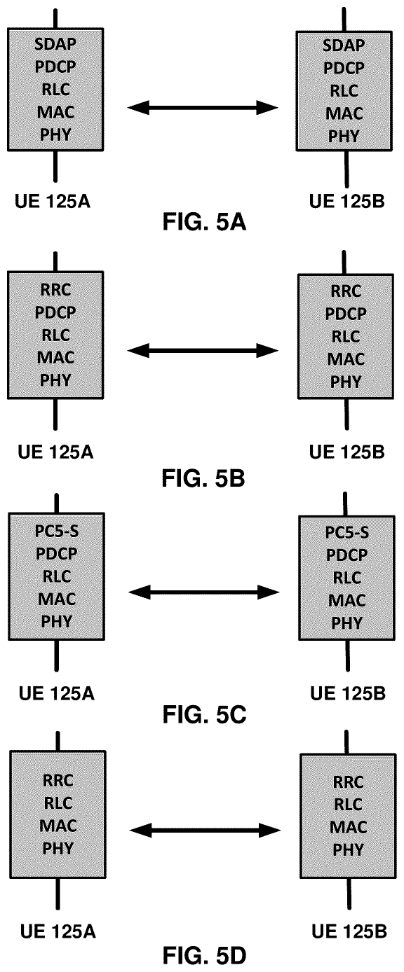

FIG. 5A, FIG. 5B, FIG. 5C and FIG. 5D show examples of radio protocol stacks for NR sidelink communication according to some aspects of some of various exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

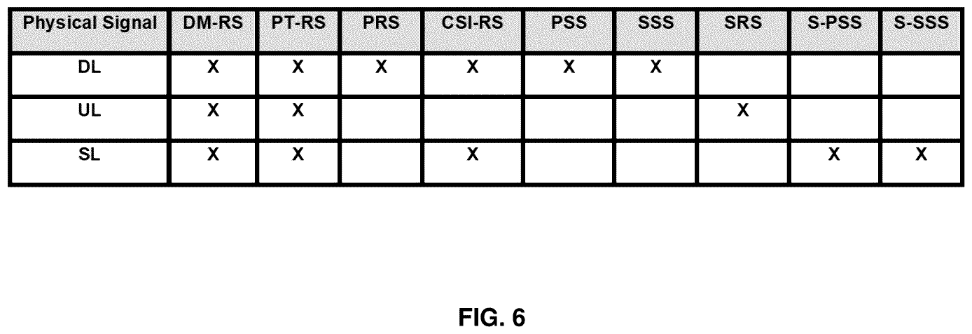

FIG. 6 shows example physical signals in downlink, uplink and sidelink according to some aspects of some of various exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transmit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attachment or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

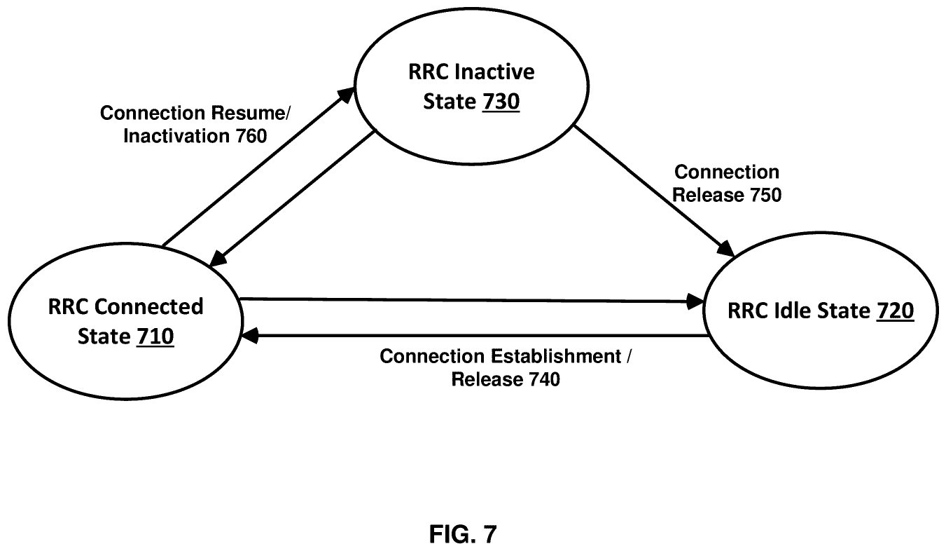

FIG. 7 shows examples of Radio Resource Control (RRC) states and transitioning between different RRC states according to some aspects of some of various exemplary embodiments of the present disclosure. A UE may be in one of three RRC states: RRC Connected State 710, RRC Idle State 720 and RRC Inactive state 730. After power up, the UE may be in RRC Idle state 720 and the UE may establish connection with the network using initial access and via an RRC connection establishment procedure to perform data transfer and/or to make/receive voice calls. Once RRC connection is established, the UE may be in RRC Connected State 710. The UE may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC Inactive State 730 to RRC Idle State 720 using an RRC Connection Release procedure 750.

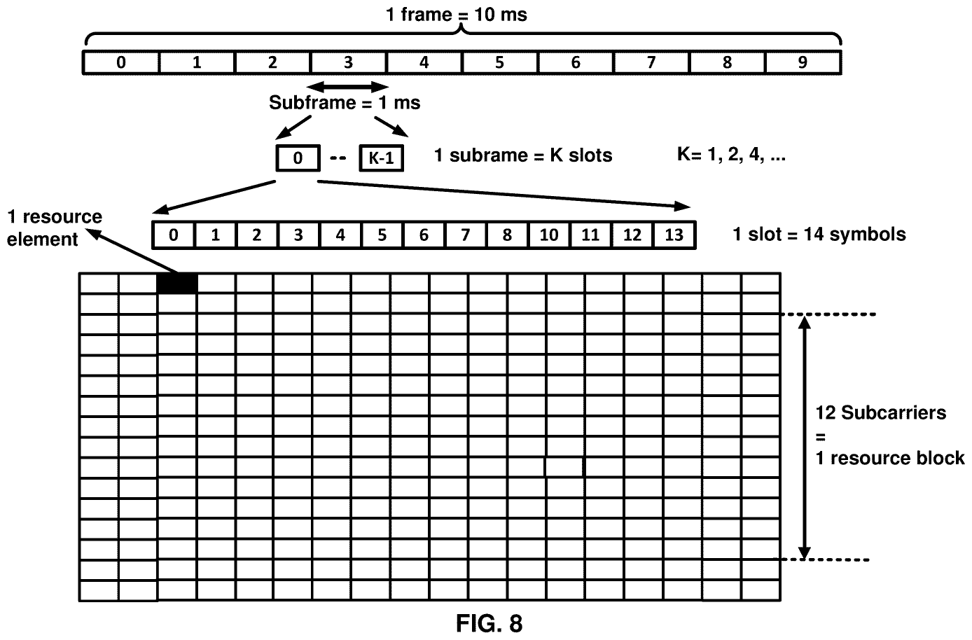

FIG. 8 shows example frame structure and physical resources according to some aspects of some of various exemplary embodiments of the present disclosure. The downlink or uplink or sidelink transmissions may be organized into frames with 10 ms duration, consisting of ten 1 ms subframes. Each subframe may consist of 1, 2, 4, . . . slots, wherein the number of slots per subframe may depend on the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

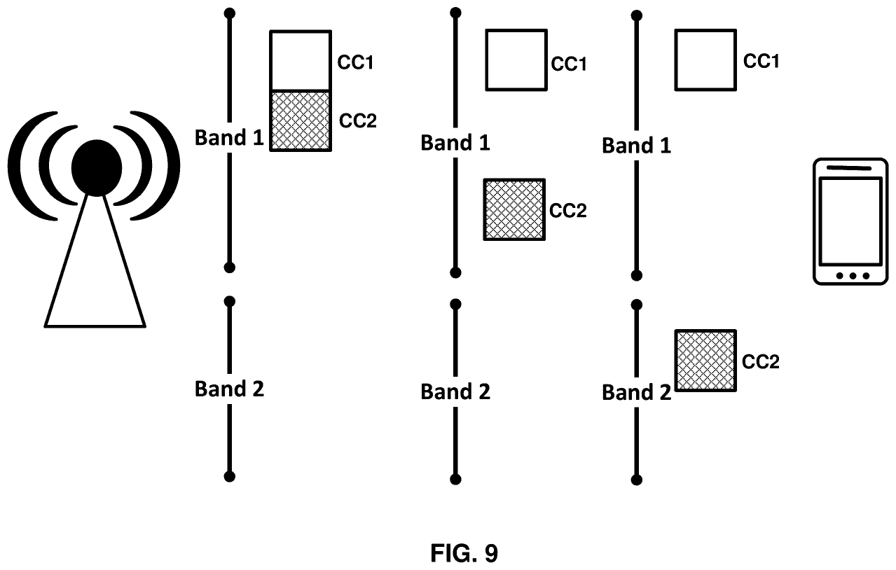

FIG. 9 shows example component carrier configurations in different carrier aggregation scenarios according to some aspects of some of various exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 9. A gNB and the UE may communicate using a serving cell. A serving cell may be associated with at least with one downlink CC (e.g., may be associated only with one downlink CC or may be associated with a downlink CC and an uplink CC). A serving cell may be a Primary Cell (PCell) or a Secondary cCell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity and for the MCG for communications with the master base station and one MAC entity for the SCG for communications with the secondary base station.

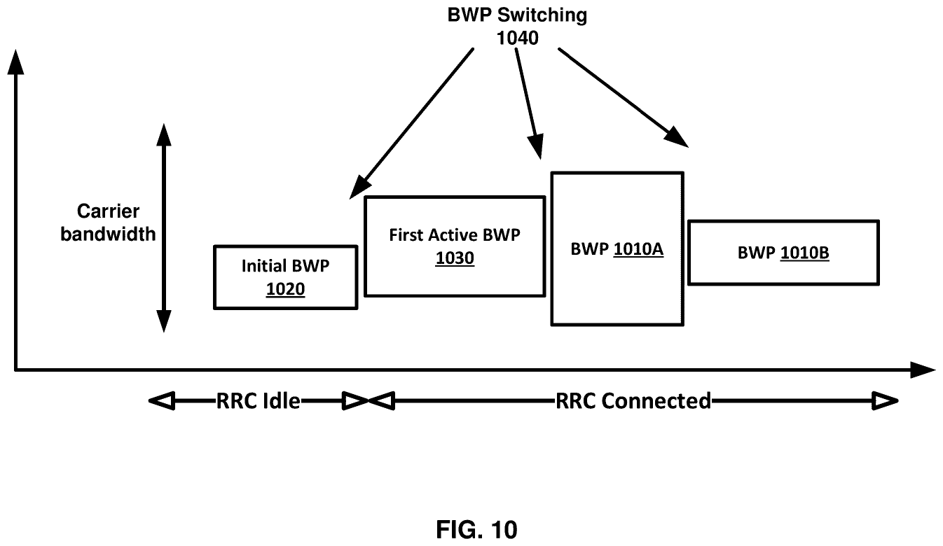

FIG. 10 shows example bandwidth part configuration and switching according to some aspects of some of various exemplary embodiments of the present disclosure. The UE may be configured with one or more Bandwidth Parts (BWPs) 1010 on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 1020 determined from system information may be used. With Bandwidth Adaptation (BA), for example through BWP switching 1040, the receive and transmit bandwidth of a UE may not be as large as the bandwidth of the cell and may be adjusted. For example, the width may be ordered to change (e.g., to shrink during period of low activity to save power); the location may move in the frequency domain (e.g., to increase scheduling flexibility); and the subcarrier spacing may be ordered to change (e.g., to allow different services). The first active BWP 1020 may be the active BWP upon RRC (re-)configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with an OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

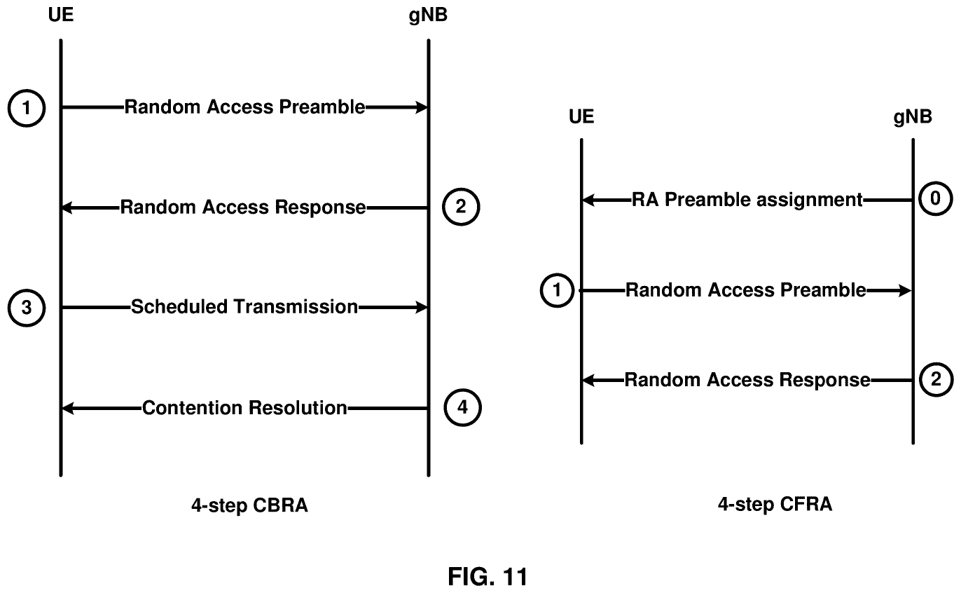

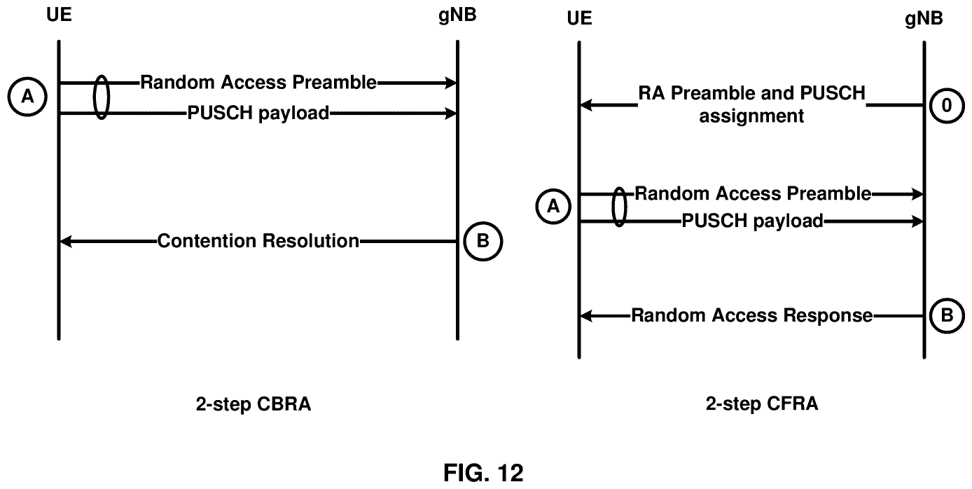

FIG. 11 shows example four-step contention-based and contention-free random access processes according to some aspects of some of various exemplary embodiments of the present disclosure. FIG. 12 shows example two-step contention-based and contention-free random access processes according to some aspects of some of various exemplary embodiments of the present disclosure. The random access procedure may be triggered by a number of events, for example: Initial access from RRC Idle State; RRC Connection Re-establishment procedure; downlink or uplink data arrival during RRC Connected State when uplink synchronization status is “non-synchronized”; uplink data arrival during RRC Connected State when there are no PUCCH resources for Scheduling Request (SR) available; SR failure; Request by RRC upon synchronous reconfiguration (e.g. handover); Transition from RRC Inactive State; to establish time alignment for a secondary TAG; Request for Other System Information (SI); Beam Failure Recovery (BFR); Consistent uplink Listen-Before-Talk (LBT) failure on PCell.

Two types of Random Access (RA) procedure may be supported: 4-step RA type with MSG1 and 2-step RA type with MSGA. Both types of RA procedure may support Contention-Based Random Access (CBRA) and Contention-Free Random Access (CFRA) as shown in FIG. 11 and FIG. 12.

The UE may select the type of random access at initiation of the random access procedure based on network configuration. When CFRA resources are not configured, an RSRP threshold may be used by the UE to select between 2-step RA type and 4-step RA type. When CFRA resources for 4-step RA type are configured, UE may perform random access with 4-step RA type. When CFRA resources for 2-step RA type are configured, UE may perform random access with 2-step RA type.

The MSG1 of the 4-step RA type may consist of a preamble on PRACH. After MSG1 transmission, the UE may monitor for a response from the network within a configured window. For CFRA, dedicated preamble for MSG1 transmission may be assigned by the network and upon receiving Random Access Response (RAR) from the network, the UE may end the random access procedure as shown in FIG. 11. For CBRA, upon reception of the random access response, the UE may send MSG3 using the uplink grant scheduled in the random access response and may monitor contention resolution as shown in FIG. 11. If contention resolution is not successful after MSG3 (re)transmission(s), the UE may go back to MSG1 transmission.

The MSGA of the 2-step RA type may include a preamble on PRACH and a payload on PUSCH. After MSGA transmission, the UE may monitor for a response from the network within a configured window. For CFRA, dedicated preamble and PUSCH resource may be configured for MSGA transmission and upon receiving the network response, the UE may end the random access procedure as shown in FIG. 12. For CBRA, if contention resolution is successful upon receiving the network response, the UE may end the random access procedure as shown in FIG. 12; while if fallback indication is received in MSGB, the UE may perform MSG3 transmission using the uplink grant scheduled in the fallback indication and may monitor contention resolution. If contention resolution is not successful after MSG3 (re)transmission(s), the UE may go back to MSGA transmission.

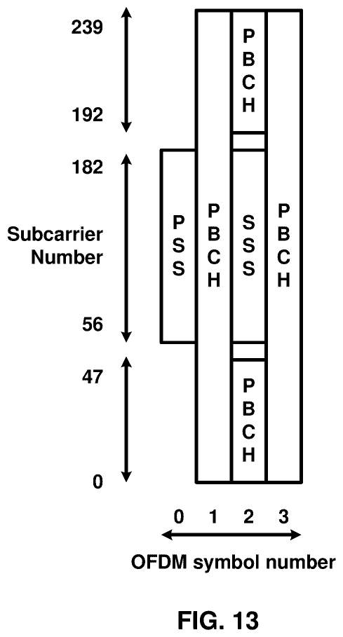

FIG. 13 shows example time and frequency structure of Synchronization Signal and Physical Broadcast Channel (PBCH) Block (SSB) according to some aspects of some of various exemplary embodiments of the present disclosure. The SS/PBCH Block (SSB) may consist of Primary and Secondary Synchronization Signals (PSS, SSS), each occupying 1 symbol and 127 subcarriers (e.g., subcarrier numbers 56 to 182 in FIG. 13), and PBCH spanning across 3 OFDM symbols and 240 subcarriers, but on one symbol leaving an unused part in the middle for SSS as show in FIG. 13. The possible time locations of SSBs within a half-frame may be determined by sub-carrier spacing and the periodicity of the half-frames, where SSBs are transmitted, may be configured by the network. During a half-frame, different SSBs may be transmitted in different spatial directions (i.e., using different beams, spanning the coverage area of a cell).

The PBCH may be used to carry Master Information Block (MIB) used by a UE during cell search and initial access procedures. The UE may first decode PBCH/MIB to receive other system information. The MIB may provide the UE with parameters required to acquire System Information Block 1 (SIB1), more specifically, information required for monitoring of PDCCH for scheduling PDSCH that carries SIB1. In addition, MIB may indicate cell barred status information. The MIB and SIB1 may be collectively referred to as the minimum system information (SI) and SIB1 may be referred to as remaining minimum system information (RMSI). The other system information blocks (SIBs) (e.g., SIB2, SIB3, . . . , SIB10 and SIBpos) may be referred to as Other SI. The Other SI may be periodically broadcast on DL-SCH, broadcast on-demand on DL-SCH (e.g., upon request from UEs in RRC Idle State, RRC Inactive State, or RRC connected State), or sent in a dedicated manner on DL-SCH to UEs in RRC Connected State (e.g., upon request, if configured by the network, from UEs in RRC Connected State or when the UE has an active BWP with no common search space configured).

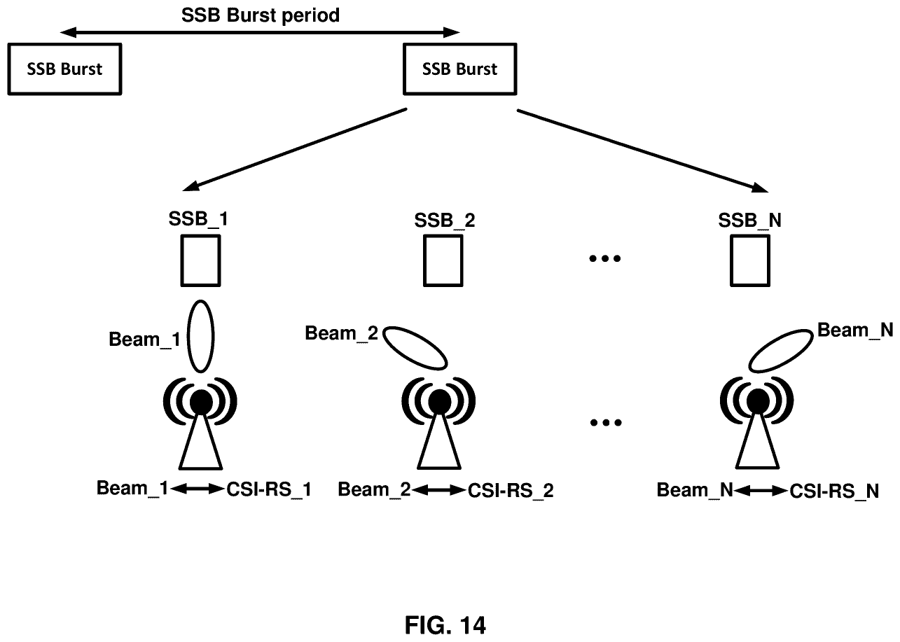

FIG. 14 shows example SSB burst transmissions according to some aspects of some of various exemplary embodiments of the present disclosure. An SSB burst may include N SSBs and each SSB of the N SSBs may correspond to a beam. The SSB bursts may be transmitted according to a periodicity (e.g., SSB burst period). During a contention-based random access process, a UE may perform a random access resource selection process, wherein the UE first selects an SSB before selecting a RA preamble. The UE may select an SSB with an RSRP above a configured threshold value. In some embodiments, the UE may select any SSB if no SSB with RSRP above the configured threshold is available. A set of random access preambles may be associated with an SSB. After selecting an SSB, the UE may select a random access preamble from the set of random access preambles associated with the SSB and may transmit the selected random access preamble to start the random access process.

In some embodiments, a beam of the N beams may be associated with a CSI-RS resource. A UE may measure CSI-RS resources and may select a CSI-RS with RSRP above a configured threshold value. The UE may select a random access preamble corresponding to the selected CSI-RS and may transmit the selected random access process to start the random access process. If there is no random access preamble associated with the selected CSI-RS, the UE may select a random access preamble corresponding to an SSB which is Quasi-Collocated with the selected CSI-RS.

In some embodiments, based on the UE measurements of the CSI-RS resources and the UE CSI reporting, the base station may determine a Transmission Configuration Indication (TCI) state and may indicate the TCI state to the UE, wherein the UE may use the indicated TCI state for reception of downlink control information (e.g., via PDCCH) or data (e.g., via PDSCH). The UE may use the indicated TCI state for using the appropriate beam for reception of data or control information. The indication of the TCI states may be using RRC configuration or in combination of RRC signaling and dynamic signaling (e.g., via a MAC Control element (MAC CE) and/or based on a value of field in the downlink control information that schedules the downlink transmission). The TCI state may indicate a Quasi-Colocation (QCL) relationship between a downlink reference signal such as CSI-RS and the DM-RS associated with the downlink control or data channels (e.g., PDCCH or PDSCH, respectively).

In some embodiments, the UE may be configured with a list of up to M TCI-State configurations, using Physical Downlink Shared Channel (PDSCH) configuration parameters, to decode PDSCH according to a detected PDCCH with DCI intended for the UE and the given serving cell, where M may depend on the UE capability. Each TCI-State may contain parameters for configuring a QCL relationship between one or two downlink reference signals and the DM-RS ports of the PDSCH, the DM-RS port of PDCCH or the CSI-RS port(s) of a CSI-RS resource. The quasi co-location relationship may be configured by one or more RRC parameters. The quasi co-location types corresponding to each DL RS may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}. The UE may receive an activation command (e.g., a MAC CE), used to map TCI states to the codepoints of a DCI field.

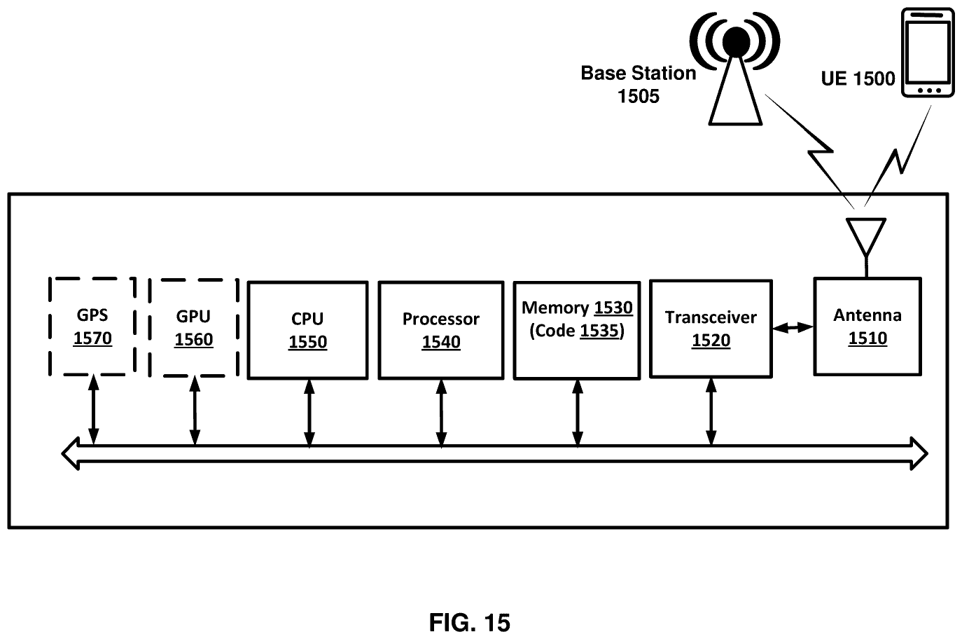

FIG. 15 shows example components of a user equipment and a base station for transmission and/or reception according to some aspects of some of various exemplary embodiments of the present disclosure. All or a subset of blocks and functions in FIG. 15 may be in the base station 1505 and the user equipment 1500 and may be performed by the user equipment 1500 and by the base station 1505. The Antenna 1510 may be used for transmission or reception of electromagnetic signals. The Antenna 1510 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 150 may enable a massive MIMO configuration with tens or hundreds of antenna elements. The Antenna 1510 may enable other multi-antenna techniques such as beamforming. In some examples, depending on the UE 1500 capabilities or the type of UE 1500 (e.g., a low-complexity UE), the UE 1500 may support a single antenna only.

The transceiver 1520 may communicate bi-directionally, via the Antenna 1510, wireless links as described herein. For example, the transceiver 1520 may represent a wireless transceiver at the UE and may communicate bi-directionally with the wireless transceiver at the base station or vice versa. The transceiver 1520 may include a modem to modulate the packets and provide the modulated packets to the Antennas 1510 for transmission, and to demodulate packets received from the Antennas 1510.

The memory 1530 may include RAM and ROM. The memory 1530 may store computer-readable, computer-executable code 1535 including instructions that, when executed, cause the processor to perform various functions described herein. In some examples, the memory 1530 may contain, among other things, a Basic Input/output System (BIOS) which may control basic hardware or software operation such as the interaction with peripheral components or devices.

The processor 1540 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1540 may be configured to operate a memory using a memory controller. In other examples, a memory controller may be integrated into the processor 1540. The processor 1540 may be configured to execute computer-readable instructions stored in a memory (e.g., the memory 1530) to cause the UE 1500 or the base station 1505 to perform various functions.

The Central Processing Unit (CPU) 1550 may perform basic arithmetic, logic, controlling, and Input/output (I/O) operations specified by the computer instructions in the Memory 1530. The user equipment 1500 and/or the base station 1505 may include additional peripheral components such as a graphics processing unit (GPU) 1560 and a Global Positioning System (GPS) 1570. The GPU 1560 is a specialized circuitry for rapid manipulation and altering of the Memory 1530 for accelerating the processing performance of the user equipment 1500 and/or the base station 1505. The GPS 1570 may be used for enabling location-based services or other services for example based on geographical position of the user equipment 1500.

In some examples, in addition to V2X applications, NR sidelink may be used in commercial use cases. For commercial sidelink applications, two key requirements may be increased sidelink data rate and support of new carrier frequencies for sidelink. Increased sidelink data rate may be motivated by applications such as sensor information (video) sharing between vehicles with high degree of driving automation. Increased data rate can be achieved with the support of sidelink carrier aggregation and sidelink over unlicensed spectrum. Furthermore, by enhancing the FR2 sidelink operation, increased data rate may be more efficiently supported on FR2. With the support of unlicensed spectrum and the enhancement in FR2, sidelink may be in a better position to be implemented in commercial devices since utilization of the ITS band may be limited to ITS safety related applications.

In some examples, sidelink on unlicensed spectrum may be used for both mode 1 and mode 2 where Uu operation for mode 1 may be limited to licensed spectrum. A channel access mechanism may be used for sidelink unlicensed operation.

In some examples in NR sidelink (SL), time and frequency resources may be configured to the UE in the form of resource pool configuration. Furthermore, subchannel may be defined as part of resource pool configuration and may determine the minimum scheduling granularity for PSSCH transmission in the frequency domain.

In some examples, the size of the resource pool in the frequency domain may not be smaller than a channel size (e.g., 20 MHz) on an unlicensed band. In some examples, LBT may be performed per channel (e.g., 20 MHz) basis.

In some examples, the subchannel size may not exceed a channel size (e.g., 20 MHz) on an unlicensed band. The subchannel size exceeding a channel size may restrict the coexistence of UEs supporting different bandwidths and produce bandwidth fragmentation because LBT is performed per channel.

In some examples, the size of resource pool in frequency domain may exceed a channel size and may be configured to span integer multiple channels in case of wideband mode-2 SL-U operation. In some examples, SL-U transmissions from different UEs may be FDMed within the same channel of unlicensed band.

In some examples, besides 20 MHz operation, NR-U may support wideband operation (>20 MHz) which may be based on either aggregation of multiple carriers (e.g., wideband mode 1) or single carrier (e.g., wideband mode 2). The listen-before-talk (LBT) or clear channel access (CCA) may be performed for each 20 MHz channel. In some examples, clear channel assessment (CCA, e.g., LBT) may be performed for each channel (i.e., 20 MHz).

In some examples, in wideband mode 1, each channel may be as an individual carrier and aggregation of multiple carriers may be performed following the carrier aggregation (CA) procedures of NR Uu.

In some examples, wideband mode 1 (based on CA procedures) may be the simplest mode to support wideband (>20 MHz) SL-U operation.

In some examples, for wideband mode 2, it may be considered that the carrier has bandwidth greater than the channel (20 MHz) as defined for unlicensed bands (i.e., carrier bandwidth>channel bandwidth).

In some examples, carrier aggregation may be used over sidelink. In some examples, sidelink may be used in unlicensed/shared spectrum.

In some examples, sidelink synchronization, automatic gain control (AGC), channel sensing/reservation with clear channel assessment (CCA) procedure and Channel Occupancy Time (COT) sharing of NR-U may be used for sidelink operation in unlicensed bands. Such solution may enable congestion and QoS control based on UE's feedback and service types.

In some examples, the carrier sensing for clear channel assessment (CCA) and transmissions in NR-U may be based on 20 MHz LBT Subbands or Resource Block Set (RBS). Side-link Unlicensed operation in the target bands, e.g., 5 GHz and 6 GHz, may reuse the same LBT subband or Resource Block Set (RBS) as Uu interface to facilitate coexistence.

In some examples, SL-U Resource Pools may be configured as a combination 20 MHz RBS/CCs and may be aligned with those in Uu link.

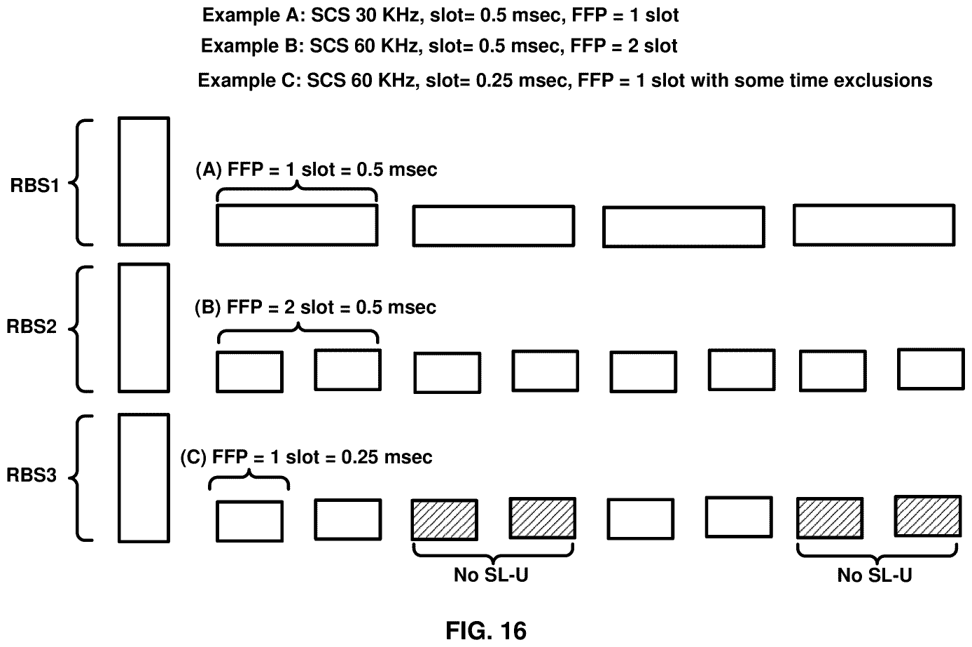

In some examples, given unlicensed spectrum may be used/shared by both access and sidelink communications the resource pools (RP) configured for SL-U communication may be separated from resource used by NR-U for Uu communications. This approach may enable more efficient and yet manageable sharing of resources to meet diverse set of requirements across NR-U and SL-U use cases. The RAN may restrict the use of SL-U on some of CCs/RBSs configured in unlicensed spectrum. Alternatively, or in addition Resource Pool restrictions may be applied in the time domain, so the SL-U configuration may restrict transmissions to some of time resources, e.g., subset of slots in the frame, e.g., not used by Uu interface, as shown in FIG. 16.

In some SL-U deployment models and use cases, efficient coexistence of side-link and access link transmission may require separating the time/frequency resources allowed for SL from those expected to be used, perhaps more heavily, for access.

In some examples, the subset of frequency resources, e.g., RBSs in shared/unlicensed spectrum, which are available for Side-link Communication may be configured by the RAN or preconfigured on the UE.

In some examples, the subset of time resources associated with an CC/RBS in shared/unlicensed spectrum which are available for sidelink for Communication may be configured by the RAN or preconfigured on the UE.

In some examples, the NR-U is 3GPP may define dynamic and semi-static access modes to shared spectrum. In Dynamic channel Access Mode (DCAM) mode of operation or also referred to as Load based Equipment (LBE), a device may perform LBT with the intention to acquire a COT at any time and there are four LBT types that have been defined under different conditions. In Semi-static channel access mode (SSCAM) of operation also referred to Frame Based Equipment (FBE), a device may only acquire a COT in specific instances of time defined by a Fixed Frame Period (FFP) and may be forbidden to transmit within the last portion of the COT (last 5 % of the COT or at least last 100 us) which may be left unused so that to allow other devices to perform LBT and acquire the channel. The Semi-static access mode may be suited for controlled environments where presence of other access technologies, like Wi-Fi or their material impact may be ruled out by deployments or through measurements.

In some examples, one advantage of DCAM may be timing flexibility of LBT and data transmission which may be supported in 5G NR through flexible start times. In sidelink communications, some restrictions on start times may be needed to ensure effective SL Synchronization, Automatic Gain Control, and inter-UE coordination.

In some examples, sidelink communications in 5G NR may involve the use of Automatic Gain Control (AGC) symbol at the beginning of each SL slot transmission to help receiving UEs with automatic gain control. Such design may be complicated with dynamic DCAM if used with flexible start time. The use of Semi-static Channel Access may result in a more predictable transmission of AGC symbols which may help with more effective gain control by the receiving UEs.

In some examples, for SL synchronization where one UE may be configured to transmission SL-SSB as reference source of synchronization for nearby UEs. Such SL synchronization may be facilitated with a predictable transmission timing, which may be easier to achieve with a SSCAM. In some SL communication use cases where synchronization, AGC and inter-UE coordination are critical and have high priorities, the SSCAM may be preferred.

In some examples, semi-static Channel Access may be more effective to enable SL synchronization and AGC.

Given extra challenges in SL synchronization and UE-UE coordination needed for QoS management in shared/unlicensed channels the semi-static access mode may be preferred when configured by the network and allowed by the environment.

In some examples, use of SSCA in SL-U may allow more effective UE-UE coordination and more predictable QoS support.

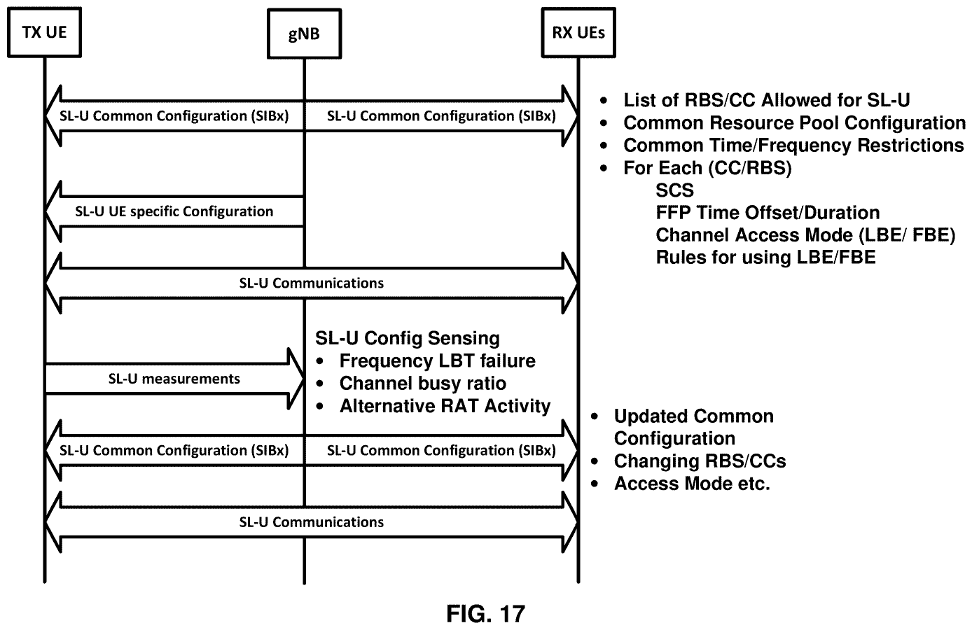

In some examples, given there are design trade-off in using SSCAM and DCAM depending on the presence of other access technologies, sidelink traffic types and use cases the one or both access modes may be configured by network to be used by the UEs. The use of Dynamic or Semi-static Channel Access (DCA/SSCA) for side-link communication may be configured on a per RBSs basis so that some RBS may use dynamic, and some may use Semi-static Access, as shown in FIG. 17.

In some examples, SL-U configuration signaling may allow per RBS/CC configuration of DCA/SSCA modes.

In some examples, the SL-U in 5G NR may be used by different applications with different traffic characteristics, QoS/latency requirements, and deployment models. Channel access, data transmission and control signaling latencies may be considered in configuration FFP duration and SubCarrier Spacing (SCS) and Slot of SL-U carriers. Note that for 5G NR SCS of 15/30/60 KHz duration of 1/0.5/0.25 msec respectively. Larger SCS and Shorter FFPs may be useful to lower latency for channel access and transmission. When needed, using shorter FFP and/or wider Subcarrier Spacing may lower the user and control plane latencies associated SL communications.

In some examples, configuring multiple RBS/CCs with FFPs of different duration and offsets may provide UE with more flexible start time for LBS and hence may lower the latency.

In some examples, configuring multiple RBS/CCs with different SCS may provide UE with more flexible options to handle traffic with different latency requirements.

In some examples, SL-U configuration signaling may allow per RBS/CC configuration of FFP duration and time offsets. In some examples, SL-U configuration signaling may allow per RBS/CC configuration of SCS.

In some examples, the configuration of channel access mode, i.e., DCA/SSCA, the FFP Offset and SCS use on an RBS/CC may be common for all UEs within a cell.

In some examples, in cases where the mix of channel access mode presents lower risk of performance, an RBS/CC may be configured with both channel access mode with one being the preferred and the other as alternative for each traffic type. In this case UE may start with a preferred mode e.g., SSCA and fall back to alternative e.g., DCA if frequent LBT failure happen.

In some examples, RAN may configure an RBS/CC with both channel access modes, in which case the RAN may include conditions under which one mode may be preferred based on traffic type/priority and conditions for fall back to alternative mode.

In some examples, the RAN may have control of most efficient mix of DCA and SSCA to use across different RBS/CCs available for SL-U. Such mix may be determined or changed based on traffic types and congestion observed on SL RBS/CCs. To assist the RAN, UEs may be configured with some SL-U measurements to report high channel occupancy or LBT failure on RBSs which may result to changing some of parameter such channel access mode, FFP durations etc. For example, an RBS/CC configured to use SSCA that involves frequent LBT failures may be changed to changing the channel access mode or setting rules for UEs to use alternative RBS/UEs may be useful, as shown in FIG. 17.

In some examples, SL-U control signaling may support configuring UEs with some channel congestion measurement and reporting based on event triggers related to LBT failures and/or nearby presence of other RATs to help RAN with possible reconfiguration of channel access modes and parameters.

In some examples, given the proximity to alternative RAT may be location depended, the use of SSCA may also be allowed/enabled based on UE's location.

In some examples, the SL-U control signaling may support use of DCA/SSCA based on UE's location, e.g., defining a geographical zone within which SSCA is preferred.

In some examples, given the periodicity of some of V2X traffic and other sidelink applications, it may be beneficial to configure FFPs periodicity based on traffic types. When multiple CCs/RBSs are used for SL-U users they may be configured differently to optimize for certain traffic types and applications and users directed to use specific such CC/RBSs based on traffic types, application/user priorities etc.

In some examples, RAN may restrict UEs to use SL-U CC/RBSs based on traffic types and user/application priorities. Some traffic types are periodic and may be handled with configured scheduling by the RAN in side-link Mode 1 and periodic resource reservation in Mode 2.

In some examples, SL-U control signaling may allow configuration of specific rules, e.g., based on traffic and user priority, be applied by UEs in selecting RBS/CCs for SL-U transmission. In some examples, the rules may be configured commonly for all UEs within cell, and they may apply the rules autonomously to use appropriate RBS/CCs. In some examples, the UE may request for SL communication for specific traffic type and the RAN may indicate which RBS/CC to be used by the UE.

In some examples, the common parameters for SL-U operation may be broadcast and updated as needed as system information (SIBs) and/or dedicated RRC signaling, as shown in FIG. 17.

In some examples, SL RAN level common parameters for SL-U including RBS configurations may be set through SIB or Dedicated RRC signaling. In some examples, SIB signaling for NR-U may be extended to include SL-U Configuration. In some examples, SIB signaling for SL may be extended to include SL-U Configuration. In some examples, a new SIB may be defined to provide SL-U Configuration.

In some examples, the SL-U configuration may include the following parameters: set of RBS/CCs available for SL-U, SL-U Resource Pool time and frequency configuration/restrictions, rules of Access Mode Selection (Traffic/Priority/Location), SL-U Congestion Measurement Configuration, per RBS/CC Configurations: subcarrier spacing, channel access mode (LBE and/or FBE), LBT Parameters for LBE, FFP Time Offset and Durations for FBE.

In some examples, in addition to common configuration parameters for SL-U, a UE may be configured with UE specific configuration. In some examples, there may be some UE specific SL-U configurations which may be provided to UE through dedicated RRC signaling which complement or override common parameters.

The use of existing sidelink communication processes in unlicensed bands may lead to inefficient and degraded UE and network performance. There is a need to enhance the existing sidelink processes when a UE is configured to perform sidelink data and/or control transmission via unlicensed resources. Example embodiments enhance the existing sidelink processes when a UE is configured to perform sidelink data and/or control transmission via unlicensed resources.

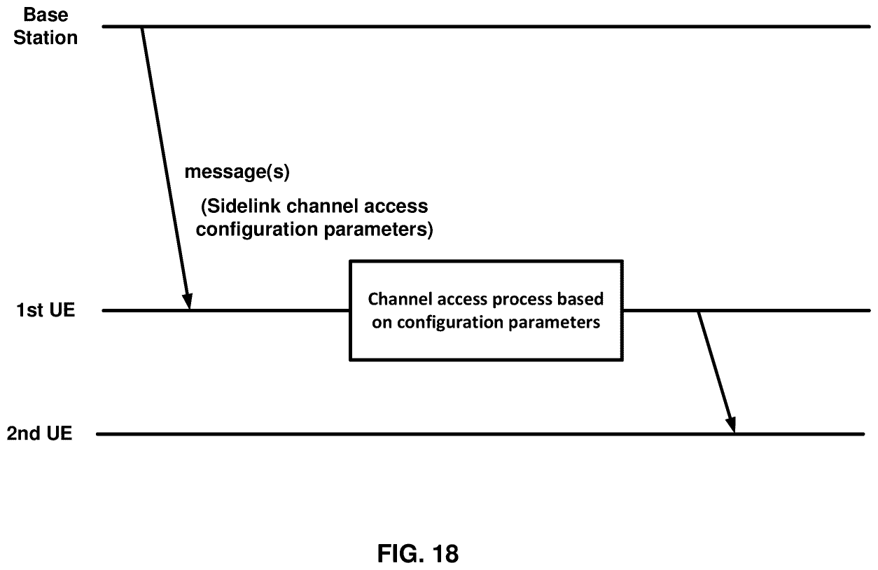

In an example embodiment as shown in FIG. 18, a first UE may be configured to perform sidelink communications over an unlicensed band. The first UE may receive, from a base station, configuration parameters of one or more cells comprising one or more unlicensed cells. At least one of the one or more unlicensed cells may be used for sidelink unlicensed communications with one or more other UEs. The sidelink unlicensed communications may be referred to as SL-U. The first UE may receive, from a base station, one or more messages comprising channel access configuration parameters used in sidelink communications via radio resources of an unlicensed band. The channel access configuration parameters may be used by the first UE, for example, to perform a listen before talk procedure and/or to determine whether channel (e.g., radio resources of an unlicensed band) is available for transmission of sidelink data and/or sidelink control information. The first UE may perform a channel access procedure based on the channel access configuration parameters. In response to the channel access procedure indicating that the channel is available, the first UE may transmit sidelink data and/or sidelink control information.

In some examples, the channel access procedure, performed by the first UE may be one of a plurality of channel access procedures. In some examples, the channel access procedure, performed by the first UE, may be a semi-static channel access process. In a semi-static channel access procedure, channel access attempt and/or listen before talk may be performed at specific instances in time. For example, the time instances for the channel access attempt may be based on a fixed frame period (FFP). The UE may determine the time instances for the channel access based on the FFP. In some examples, the channel access procedure, performed by the first UE, may be a dynamic channel access procedure. In a dynamic channel access procedure, the UE may perform the channel access process (e.g., initiate the LBT procedure) in any arbitrary point of time.

In some examples, the channel access procedure and/or the LBT procedure may be performed at units of channel bandwidth, e.g., in multiples of 20 MHz. In some examples, the units of bandwidth for performing the channel access procedure for sidelink may be aligned with units of bandwidth for performing the channel access procedure for the Uu interface.

In some examples, a first subset of resource blocks of an unlicensed band that are used for Uu interface communications and a second subset of resource blocks of the unlicensed band that are used for sidelink communications may be disjoint subsets. The resource blocks for performing channel access and/or data/control communications via the sidelink may be separate (e.g., in frequency domain) from the resource blocks for performing channel access and/or data/control communications via the Uu interface.

In some examples, a first subset of time periods that are used for Uu interface communications and a second subset of time periods that are used for sidelink communications may be disjoint subsets. The first time periods for performing channel access and/or data/control communications via the sidelink may be separate (e.g., in time domain) from the second time periods for performing channel access and/or data/control communications via the Uu interface.

In some examples, the first UE may receive first configuration parameters indicating per resource block set (RBS) or per carrier configuration of a type of the channel access process. Different RBSs and/or carriers may be associated with different types of channel access process (e.g., semi-static channel access process or dynamic channel access process). In some examples, the first configuration parameters may indicate/instruct the first UE for which resource block sets (RBSs) or for which carriers to use semi-static channel access process and for which RBSs or for which carriers use dynamic channel access process. In some examples, in case the first UE uses a semi-static channel access process, the first UE may determine based on the first configuration parameters and the first configuration parameters may indicate per resource block set (RBS) or per carrier fixed frame period for a semi-static channel access process. In some examples, the first configuration parameters may further indicate per resource block set (RBS) or per carrier sub-carrier spacing (SCS). In some examples, at least some of the first configuration parameters may user equipment (UE)-specific parameters that are specifically configured for the first UE. In some examples, at least some of the first configuration parameters may be common parameters that are commonly configured for a plurality of UEs. In some examples, the first configuration parameters may indicate that both of semi-static channel access process and dynamic channel access process are configured for a resource block set (RBS) or a carrier and/or no specific indication of the type of channel access process for an RBS or carrier may be received by the first UE. In some examples, the type of channel access process for an RBS or a carrier may be subject to one or more conditions. Under one or more first conditions, the first UE may utilize a semi-static channel access process and under one or more second conditions, the first UE may utilize a dynamic channel access process. In some examples, the first configuration received by the first UE may indicate the one or more first conditions and the one or more second conditions. The first UE may determine whether the one or more first conditions are met and may determine whether the one or more second conditions are met. In response to the determination that the one or more first conditions are met (e.g., for an RBS and/or carrier), the first UE may use the semi-static channel access process and in response to the determination that the one or more second conditions are met (e.g., for an RBS and/or carrier), the first UE may use the dynamic channel access process.

In some examples, the first UE may transmit, to the base station, channel congestion and measurement reports (e.g., as part of a UE assistance message) based on triggers related to LBT failures, e.g., number of LBT failures, nature of LBT failures, etc. In some examples, the triggers may be configurable by the base station. The first UE may receive configuration parameters indicating the triggers. In response to transmission of the channel congestion and measurement reports, the first UE may receive, from the bae station, updated channel access configuration parameters.

In some examples, the first UE may transmit a message (e.g., a UE assistance message) comprising information about nearby radio access technologies (RATs). In response to transmission of the message, the first UE may receive updated channel access configuration parameters.

In some examples, the type of channel access process and/or the parameters associated with the channel access process may be based on a location of the first UE and/or the geographical zone associated with the first UE. In some examples, the first UE may transmit information to the base station indicating the location of the first UE and/or the geographical zone associated with the first UE and may receive configuration parameters indicating the type of channel access process and/or the parameters associated with the channel access process.

In some examples, the first UE may receive configuration parameters indicating rules (e.g., UE-specific rules specific to the first UE or rules applicable to a plurality of UEs) for selecting resource block sets (RBSs) and carriers for sidelink communications in unlicensed bands.

In some examples, the first UE may transmit a request for a channel access process of a specific type, e.g., based on the first UE's autonomous determination. In response to receiving the request by the base station from the first UE, the base station may transmit, to the first UE, parameters related to the specific channel access process requested by the first UE.

In some examples, the one or more messages comprising the channel access configuration parameters may comprise one or more RRC configuration messages.

In some examples, the one or more messages comprising the channel access configuration parameters may comprise one or more broadcast messages (e.g., comprising a SIB message, e.g., a SIB1 message).

In an example embodiment, a first user equipment (UE) may receive, from a base station, one or more messages comprising channel access configuration parameters used in sidelink communications via radio resources of an unlicensed band. The first UE may perform a channel access process based on the channel access configuration parameters. The first UE may transmit, to a second UE, sidelink data or control information based on the channel access process indicating that sidelink communications is allowed to be performed.

In some examples, the channel access process may be used by the first user equipment (UE) to determine whether unlicensed radio resources are available for sidelink communications.

In some examples, the channel access process may be a semi-static channel access process. In some examples, the semi-static channel access process may be based on a fixed frame period (FFP). In some examples, instances that the channel access is performed may be based on the fixed frame period (FFP).

In some examples, the channel access process may be dynamic channel access process.

In some examples, the channel access process may be for first radio resources that are 20 MHz in frequency domain.

In some examples, a first subset of resource blocks of an unlicensed band that are used for Uu interface communications and a second subset of resource blocks of the unlicensed band that are used for sidelink communications may be disjoint subsets.

In some examples, a first subset of time periods that are used for Uu interface communications and a second subset of time periods that are used for sidelink communications may be disjoint subsets.

In some examples, the first UE may receive first configuration parameters indicating per resource block set (RBS) configuration or per carrier configuration of a type of the channel access process. In some examples, the first configuration parameters may indicate which resource block sets (RBSs) or which carriers may use semi-static channel access process and which RBSs or which carriers may use dynamic channel access process. In some examples, the first configuration parameters may further indicate per resource block set (RBS) or per carrier fixed frame period for a semi-static channel access process. In some examples, the first configuration parameters may further indicate per resource block set (RBS) or per carrier sub-carrier spacing (SCS). In some examples, the first configuration parameters may be user equipment (UE)-specific parameters. In some examples, the first configuration parameters may be common among a plurality of UEs. In some examples, the first configuration parameters may indicate that both semi-static channel access process and dynamic channel access process are configured for a resource block set (RBS) or a carrier. In some examples, the first configuration parameters may indicate one or more first conditions that the channel access process is a semi-static channel access process and second conditions that the channel access process is a dynamic channel access process for a resource block set (RBS) or a carrier. In some examples, the first UE may determine, based on the one or more conditions, whether the channel access process for the resource block set (RBS) or the carrier is a semi-static channel access process or a dynamic channel access process.

In some examples, the first user equipment (UE) may transmit, to the base station, channel congestion and measurement reports based on triggers related to listen-before-talk (LBT) failures. In some examples, the first UE may receive one or more configuration parameters indicating the triggers or to determine whether the triggered are satisfied. In some examples, the first UE may receive updated channel access configuration parameters in response to transmitting the channel congestion and measurement reports.

In some examples, the first UE may receive information related to presence of nearby radio access technologies (RATs). In some examples, the first UE may receive updated channel access configuration parameters in response to transmitting the information.

In some examples, the channel access configuration parameters may indicate use of a semi-static channel access or a dynamic channel access based on a location or a geographical zone associated with the first user equipment (UE).

In some examples, the first UE may receive configuration parameters indicating rules for selecting resource block sets (RBSs) and carriers for sidelink communications in unlicensed bands. In some examples, the rules may be user equipment (UE)-specific rules. In some examples, the rules may be common rules that are applicable to a plurality of user equipments (UEs).

In some examples, the first UE may transmit a request for sidelink communications of a first type, wherein receiving the channel access configuration parameters may be based on the first type.

In some examples, the first UE may receive the channel access configuration parameters based on a broadcast message. In some examples, the broadcast message may be a system information block (SIB) message. In some examples, the system information block (SIB) message may be a SIB1 message.

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

1. A method of sidelink communications in unlicensed bands, comprising the steps of:
receiving, by a first user equipment (UE) from a base station, one or more messages comprising channel access configuration parameters used in sidelink communications via radio resources of an unlicensed band;
performing a channel access process based on the channel access configuration parameters; and
transmitting, by the first UE to a second UE, sidelink data or control information based on the channel access process indicating that sidelink communications are allowed to be performed.

2. The method of claim 1, wherein the channel access process is used by the first user equipment (UE) to determine whether unlicensed radio resources are available for sidelink communications.

3. The method of claim 1, wherein the channel access process is a semi-static channel access process.

4. The method of claim 3, wherein the semi-static channel access process is based on a fixed frame period (FFP).

5. The method of claim 4, wherein instances that the channel access is performed are based on the fixed frame period (FFP).

6. The method of claim 1, wherein the channel access process is a dynamic channel access process.

7. The method of claim 1, wherein the channel access process is for first radio resources that are approximately 20 MHz in a frequency domain.

8. The method of claim 1, wherein a first subset of resource blocks of an unlicensed band that are used for Uu interface communications and a second subset of resource blocks of the unlicensed band that are used for sidelink communications are disjoint subsets.

9. The method of claim 1, wherein a first subset of time periods that are used for Uu interface communications and a second subset of time periods that are used for sidelink communications are disjoint subsets.

10. The method of claim 1, further comprising receiving first configuration parameters indicating per resource block set (RBS) configuration or per carrier configuration of a type of the channel access process.

11. The method of claim 10, wherein the first configuration parameters indicate which resource block sets (RBSs) or which carriers use semi-static channel access process and which RBSs or which carriers use a dynamic channel access process.

12. The method of claim 10, wherein the first configuration parameters further indicate a per resource block set (RBS) or a per carrier fixed frame period for a semi-static channel access process.

13. The method of claim 10, wherein the first configuration parameters further indicate a per resource block set (RBS) or a per carrier sub-carrier spacing (SCS).

14. The method of claim 10, wherein the first configuration parameters are user equipment (UE)-specific parameters.

15. The method of claim 10, wherein the first configuration parameters are common among a plurality of user equipments (UEs).

16. The method of claim 10, wherein the first configuration parameters indicate that both a semi-static channel access process and a dynamic channel access process are configured for a resource block set (RBS) or a carrier.

17. The method of claim 16, wherein the first configuration parameters indicate one or more first conditions that define the channel access process as a semi-static channel access process and second conditions that define the channel access process as a dynamic channel access process for the resource block set (RBS) or the carrier.

18. The method of claim 17, further comprising determining, based on the one or more conditions, whether the channel access process for the resource block set (RBS) or the carrier is a semi-static channel access process or a dynamic channel access process.

19. The method of claim 1, further comprising transmitting, by the first user equipment (UE) to the base station, channel congestion and measurement reports based on triggers related to listen-before-talk (LBT) failures.

20. The method of claim 19, further comprising receiving one or more configuration parameters indicating the triggers or used for determining whether the triggers are satisfied.
